(19) United States
(12) Patent Application Publication
(10) Pub. No.: US 2014/0375320 A1
(43) Pub. Date: Dec. 25, 2014

(54) METHOD OF LEAKAGE CURRENT AND BOREHOLE ENVIRONMENT CORRECTION FOR OIL BASED MUD IMAGER

(71) Applicants: Yue Liu, Beijing (CN); Qihui Zhao, Beijing (CN); Qingjie Bai, Beijing (CN); Yuzhou Lu, Beijing (CN); Zhong Wang, Houston, TX (US); Suming Wu, Houston, TX (US); Ce Liu, Houston, TX (US)

(72) Inventors: Yue Liu, Beijing (CN); Qihui Zhao, Beijing (CN); Qingjie Bai, Beijing (CN); Yuzhou Lu, Beijing (CN); Zhong Wang, Houston, TX (US); Suming Wu, Houston, TX (US); Ce Liu, Houston, TX (US)

(21) Appl. No.: 13/922,090

(22) Filed: Jun. 19, 2013

(51) Int. Cl. G01V 3/20; G01V 3/38

(52) U.S. Cl. CPC G01V 3/20; G01V 3/38
USPC 324/324

(57) ABSTRACT

A correction method for resistivity measurements of formation surrounding a borehole includes deploying a logging tool in the borehole and having a standoff in between the logging tool and the wall of the borehole, measuring a total current entering into the pair of current electrodes, computing a leakage current in the sensor pad caused by an internal capacitive impedance between the pair of current electrodes and the main body of the sensor pad, computing a measuring current to enter into the formation for the resistivity measurements by subtracting the leakage current from the total current, computing an external capacitive impedance between the current electrodes and the formation, utilizing a pre-built chart to obtain a geometric factor based on the external capacitive impedance, and computing resistivity of the formation based on the geometric factor.

### FIELD OF THE INVENTION

The present invention relates generally to the field of electrical resistivity well logging. More particularly, the invention relates to an apparatus and a method for determining the formation resistivity using electrical methods, including leakage current and borehole environment correction for oil based mud micro-resistivity imager.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain a great quantity of geological information regarding conditions and parameters encountered downhole. It is important to determine geological information with a high degree of accuracy for drilling efficiency. For example, as known in the prior art, the formation containing hydrocarbon (such as crude oil or gas) usually has higher resistivity than the formation containing water. It is preferable to keep the borehole in the pay zone (the formation with hydrocarbons) as much as possible so as to maximize the recovery.

Geological information typically includes formation resistivity (or conductivity; the terms “resistivity” and “conductivity”, though reciprocal, are often used interchangeably in the art.), dielectric constant, data relating to the configuration of the borehole, etc. Borehole images could help geologists and geophysicists define the structural position of reservoirs and characterize features, such as fractures and folds. Recently, the use of nonconductive (e.g. oil-based and synthetic) mud in drilling process has commonly utilized to reduce drilling risks and improve drilling efficiency. An oil-based mud imager (OBMI) has become more and more popular.

Micro-resistivity logging in the nonconductive fluid (e.g. oil mud) conventionally requires high frequency alternating currents so as to increase the capacitive coupling to the formation. FIGS. 1A and 1B show a side view and a front view of an illustrative sensor pad configured for four-terminal resistivity measurement as known in prior art. The sensor pad 100 can be deployed against the borehole wall for measuring the resistivity of a formation 102 near the borehole. The sensor pad 100 includes two current electrodes 104 and 106 and several voltage electrodes 108 and 110 (only one pair of the voltage electrodes 108 and 110 shown in FIG. 1A). A mud layer 112 would possibly be situated between the formation 102 and the sensor pad 100. The mud layer 112 can be made of nonconductive fluid, such as an oil-based mud or mix of it and other materials from the borehole, present in the borehole whiling drilling. It prevents the sensor pad 100 from intimately contacting with the formation 102, creating a standoff between the sensor pad 100 and the formation 102.

FIG. 2 shows a cross-sectional view of the illustrative sensor pad 100 shown in FIG. 1. The sensor pad 100 includes a metal body 200 covered with a surface of an insulating layer 202. The current electrodes 104 and 106 and voltage electrodes 108 and 110 are isolated by the insulating 202 from the metal body 200. In operation, the current electrodes 104 and 106 are used to conduct electric current (I) 204 through the formation 102. The pair of voltage electrodes 108 and 100 is used to measure the voltage difference (dV) between them. According to the Ohm's Law, the resistivity of the small interval between the pair of voltage electrodes 108 and 100 of the formation 102 can be computed as follows,

$$Rt = k \frac{dv}{I} \qquad ( 1 )$$

where k is a geometrical factor.

Therefore, we can use the current 204 to measure the formation resistivity. However, not all of the current sourcing from the current electrodes 104 or 106 can pass through the formation 102. As alternating current sources or voltages sources are applied with the current electrodes 104 and 106, the capacitive coupling between (1) the current electrodes 104 and 106 and the metal body 200 of the sensor pad 100 and (2) the current electrodes 104 and 106 and the formation 102 could be significant.

The capacitive coupling between the current electrodes 104 and 106 and the metal body 200 would cause leakage currents 208 in the sensor pad 100. The capacitive coupling between the current electrodes 104 and 106 and the formation 102 would cause bypass currents 206 in the mud layer 112 and spurious potential drops across the voltage electrodes 108 and 110. The leakage currents and bypass currents are parasitical and may affect accuracy of resistivity measurement.

Several solutions have been proposed to solve above issues. FIG. 3 shows a cross-sectional view of the illustrative sensor pad 100 applied with guard electrodes 300 and 302, voltage detectors 308 and 310, and controllable current sources 304 and 306. The two guard electrodes 300 and 302 are deployed near the current electrodes 104 and 106 and maintain at the same potential as the current electrodes 104 and 106, so as to minimize the leakage currents passing through the sensor pad 100. As to the bypass currents in the mud layer 112, the current sources 304 and 306 are used to control the amplitudes and phases of currents out of the current electrodes 104 and 106 to lower the common mode voltage Vc, preferably down to zero. As such, the bypass currents 206 can be minimized or eliminated due to the voltage potential cross the formation and the voltage electrodes 108 and 110 has been minimized or eliminated. The common mode voltage Vc is sampled from VA and VB measured by the detector 308 and 310 using an analog-to-digital converter (i.e. Vc=(V_{A}+V_{B})/2).

However, the setting of guard electrodes 300 and 302, the current sources 304 and 306, and the detectors 308 and 310 would increase the complexity of circuit design and mechanical structure of the sensor pad 100.

As described above, a need exists for an improved method for minimizing or eliminating the leakage and bypass currents.

A further need exists for an improved method for minimizing or eliminating the leakage and bypass currents without applying complicated circuits of guard electrodes, current sources, or detectors.

A further need exists for an improved method for calibrating the result of formation resistivity measurements.

The present embodiments of the apparatus and the method meet these needs and improve on the technology.

### SUMMARY OF THE INVENTION

This section provides a general summary of the disclosure, and is not a comprehensive disclosure of its full scope or its entire feature.

In one preferred embodiment, a correction method for resistivity measurements of formation surrounding a borehole includes deploying a logging tool in the borehole and having a standoff in between the logging tool and the wall of the borehole, measuring a total current entering into the pair of current electrodes, computing a leakage current in the sensor pad caused by an internal capacitive impedance between the pair of current electrodes and the main body of the sensor pad, computing a measuring current to enter into the formation for the resistivity measurements by subtracting the leakage current from the total current, computing an external capacitive impedance between the current electrodes and the formation, utilizing a pre-built chart to obtain a geometric factor based on the external capacitive impedance, and computing resistivity of the formation based on the geometric factor.

In some embodiments, the logging tool includes the sensor pad, which is embedded with a pair of current electrodes and a pair of voltage electrodes, and a measurement circuit.

In some embodiments, the current electrodes and voltage electrodes are insulated from the main body of the sensor pad.

In some embodiments, the measurement circuit provides source voltages to the pair of current electrodes;

In some embodiments, the internal capacitive impedance between the pair of current electrodes and the sensor pad is obtained by placing the sensor pad in two medium and measuring currents passing through them.

In some embodiments, the currents passing through the two medium are expressed as follows:

$$\frac{V}{{Z}_{i}} + \frac{V}{{Z}_{1}} = {I}_{1} ;$$

$$\frac{V}{{Z}_{i}} + \frac{V}{{Z}_{1}} {ɛ}_{r} = {I}_{2}$$

wherein V is the amplitude of alternating source voltage; wherein ∈ᵣ is the ratio of the dielectric constants of the two medium; wherein I₁ is the measured current flow at the pair of current electrodes when the sensor pad is deployed in the first medium; and wherein I₂ is the measured current flow at the pair of current electrodes when the sensor pad is deployed in the second medium.

In some embodiments, the internal capacitive impedance is computed as follows:

$${Z}_{i} = \frac{V ( {ɛ}_{r} - 1 )}{{I}_{1} {ɛ}_{r} - {I}_{2}}$$

In some embodiments, the external capacitive impedance is computed as follows:

$${Z}_{e} = \frac{V}{{I}_{m}}$$

wherein V is the amplitude of alternating source voltage; and wherein Iₘ is the measuring currents to enter into the formation for resistivity measurements.

In some embodiments, the method further includes checking the consistency of the external capacitive impedances when multiple external capacitive impedances are computed between each of the current electrodes and the formation.

In other embodiments, the difference between multiple external capacitive impedances indicates a tilt level of the sensor pad.

In other embodiments, the external capacitive impedances are corrected when the difference exceeds pre-defined criteria.

In other embodiments, multiple geometric factors are obtained based on multiple external capacitive impedances.

In other embodiments, a final geometric factor for computing formation resistivity is the average of multiple geometric factors.

In other embodiments, the method further includes building the pre-built chart which includes the data of geometric factor versus the external capacitive impedance with different standoffs and electrical characteristics of medium.

In other embodiments, the sensor pad is connected to the measurement circuit.

In other embodiments, the measurement circuit comprises two voltage sources connected to the pair of current electrodes.

In other embodiments, the phase difference between the pair of voltage sources is 180 degrees.

In another embodiment, the measurement circuit comprises a transformer and a current sense amplifier to measure the total current entering into the current electrodes.

In another embodiment, the measurement circuit comprises a processor to calculate resistivity.

In another embodiment, the measurement circuit comprises a differential amplifier to measure the voltage potential between the pair of voltage electrodes.

In another embodiment, the sensor pad includes a pair of standoff devices deployed at the two ends of the sensor pad to prevent direct contact between the sensor pad and the formation.

In another embodiment, results of multiple resistivity measurements generate an image of the borehole.

In another preferred embodiment, a correction method for resistivity measurements of formation surrounding a borehole includes providing a sensor pad, providing a pair of voltage sources connecting to the pair of current electrodes, providing transformers and current sense amplifiers to measure currents out of the voltage sources, providing a differential amplifier to measure and sample the voltage difference between the pair of voltage electrodes, providing a storage device to be stored with a pre-built chart including data of geometric factors in consideration of an internal capacitive impedance in the sensor pad and an external capacitive impedance between the current electrodes and the formation, and providing a processor to calculate resistivity of the formation based on the geometric factor.

In some embodiments, the sensor paid is embedded with at least a pair of current electrodes and at least a pair of voltage electrodes.

In some embodiments, the current and voltage electrodes are covered with an insulator.

In other embodiments, the voltage electrodes are deployed between the current electrodes.

In another preferred embodiment, a correction method for resistivity measurements of formation surrounding a borehole includes obtaining an internal capacitive impedance and a leakage current in a sensor pad, computing an external capacitive impedance between the current electrodes and the formation, and calibrating a geometric factor in consideration of the internal and external capacitive impedances to calculate resistivity of the formation.

In some embodiments, the sensor pad includes at least a pair of current electrodes and at least a pair of voltage electrodes.

In some embodiments, the calibration is performed by numerical modeling or calibration experiments.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIGS. 1A and 1B show a side view and a front view of an illustrative sensor pad configured for four-terminal resistivity measurement as known in prior art.

FIG. 2 shows a cross-sectional view of the illustrative sensor pad shown in FIG. 1.

FIG. 3 shows a cross-sectional view of the illustrative sensor pad applied with guard electrodes, voltage detectors, and controllable current sources.

FIG. 4 shows a cross-sectional view of a sensor pad with improved measurement circuits and structure designs according to some embodiments of the present invention.

FIG. 5 shows a circuit model for the sensor pad configuration and borehole environment shown in FIG. 4.

FIG. 6 shows a simplified circuit model for the left current electrode of the sensor pad suspended in the air.

FIG. 7 shows a simplified circuit model for the left current electrode of the sensor pad suspended in the borehole.

FIG. 8 shows an exemplary model used for demonstrating the cross relationship between the geometric factor k and the capacitive impedance Z_{eL}.

FIGS. 9A, 9B and 9C show cross plots of the inverse of the geometric factor k versus the capacitive impedance Z_{eL} based on the simulation results of the model in FIG. 8.

FIG. 10 shows a flow diagram of a correction method for an oil based mud imager with the sensor pad shown in FIG. 4.

FIG. 11 shows a flow diagram of a correction method for resistivity measurements of formation surrounding a borehole.

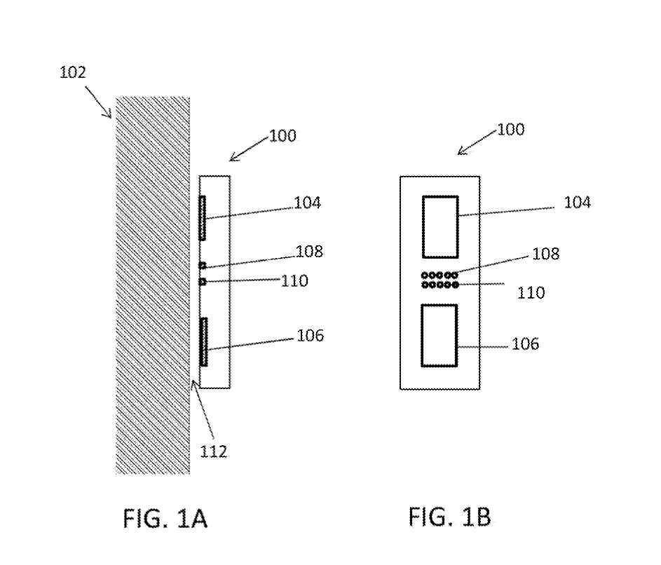

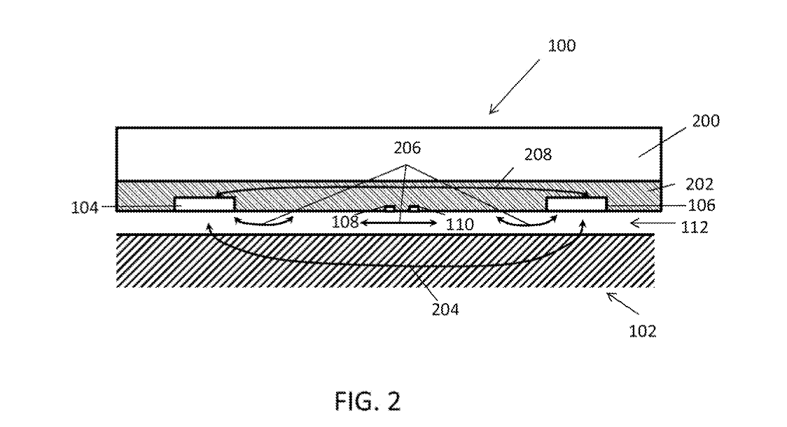

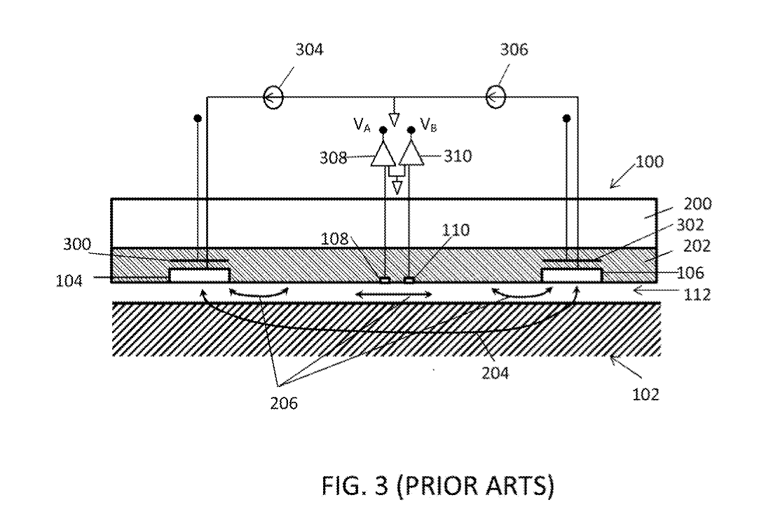

### DETAILED DESCRIPTION OF THE EMBODIMENTS

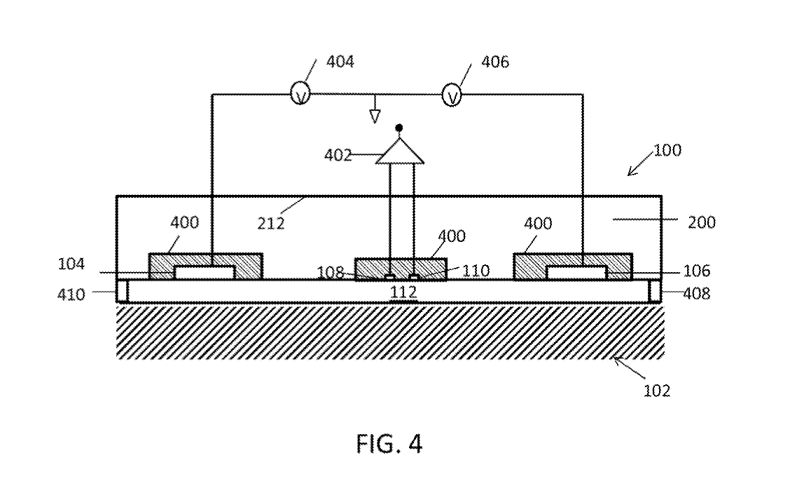

Referring now to FIGS. 4 through 11, exemplary embodiments of the present invention are depicted. It will be understood by one skilled in the art that the present invention can be well suited with an oil-based mud imager or similar imaging device. It will also be understood by one skilled in the art that the present invention can be used with any kind of subterranean drilling operation, either offshore or onshore.

FIG. 4 shows a cross-sectional view of the sensor pad 100 with improved measurement circuits and structure designs according to some embodiments of the present invention. The sensor pad 100 can include a pair of current electrodes 104 and 106 and a pair of voltage electrodes 108 and 110. The current electrodes 104 and 106 and voltage electrodes 108 and 110 can be covered with an insulating material 400 and shielded from the metal body 200 of the sensor pad 100. The size of the insulating material 400 can vary. To measure the resistivity of the formation 102, two voltage sources 404 and 406 can be applied to the pair of current electrodes 104 and 106 to generate currents entering into the formation 102 for resistivity measurements. A differential voltage amplifier 402 can be applied to the pair of voltage electrodes 108 and 110 to sample the voltage difference between the voltage electrodes 108 and 110.

In some embodiments, measurement circuits, including the differential voltage amplifier 402, the voltage sources 404 and 406, or any associated circuitry to apply or measure voltage or current, can be physically separated from the sensor pad 100.

In some embodiments, a pair of standoff devices 408 and 410 can be deployed at two ends of the sensor pad 100 to prevent the sensor pad 100 from contacting the surface of the formation 102 directly anytime during operation. The rigorous surface of the formation 102 may cause inaccuracy of measurements.

In some embodiments, the phase difference between the pair of voltage sources 404 and 406 can be 180 degrees.

In some embodiments, the sensor pad 100 can be connected to a voltage reference of the circuitry (i.e. 0V) to avoid the voltage electrodes 108 and 110 from directly coupling to the current electrodes 104 and 106 in the sensor pad 100.

The present invention is in no way limited to any number of voltage source or standoff device.

To deal with the issue of capacitive coupling between (1) the current electrodes 104 and 106 and the metal body 200 and (2) the current electrodes 104 and 106 and the formation 102, the present invention provides a method to correct leakage currents in the sensor pad 100 and bypass currents passing through the standoff between the sensor pad 100 and the formation 102 and to identify a correct geometric factor for resistivity measurements and computation.

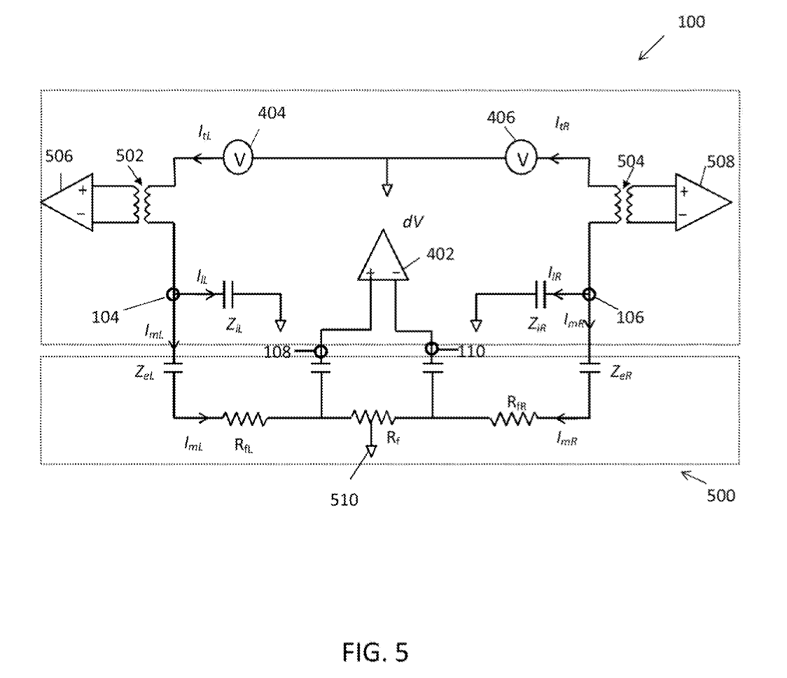

FIG. 5 shows a circuit model for the configuration of the sensor pad 100 and borehole environment 500. A first dashed block represents the sensor pad 100 shown in FIG. 4. A second dashed block 500 represents the borehole environment, including the mud layer 112 and the formation 102 depicted in the FIG. 4. Two total currents I_{tL} and I_{tR} can flow out of the voltage sources 404 and 406 respectively and be measured by current sense amplifiers 506 and 508 through transformers 502 and 504. Internal capacitive impedances Z_{iL} and Z_{iR} between the left and right current electrodes 104 and 106 and the metal body 200 can caused leakage currents I_{lL} and I_{lR} in the sensor pad 100. The rest of the measuring currents I_{mL} and I_{mR} then can flow out of the sensor pad 100 and enter into the formation through external capacitive impedances Z_{eL} and Z_{eR} between the left and right current electrodes 104 and 106 and the formation. The measuring currents I_{mL} and I_{mR} then can flow through resistors R_{fL}, R_{f}, and R_{fR}, which represents resistance in the formation. When the measuring currents I_{mL} and I_{mR} flow through resistors in the formation, a voltage potential dV can be measured by the differential amplifier 402.

In some embodiments, when the phase difference between the voltage sources 404 and 406 is 180 degrees, there can be a virtual ground 510 in front of the voltage electrodes 108 and 110.

The present invention provides a method to correct leakage currents and external capacitive impedances caused by borehole environment. The correction method for resistivity measurements of formation includes obtaining internal capacitive impedances and leakage currents in a sensor pad, which includes a pair of current electrodes and a pair of voltage electrodes, computing external capacitive impedances between the current electrodes and the formation, calibrating a geometric factor in consideration of the internal and external capacitive impedances, and calculating resistivity of the formation. The calibration can be performed by numerical modeling or calibration experiments.

The image of borehole walls can be obtained from results of multiple resistivity measurements. In measurement operations, the sensor pad 100 can be placed and suspended in two different medium for obtaining internal capacitive impedances and leakage currents generated inside of it. The second medium can have relatively high resistivity and different dielectric constant from it of the first medium. The process can be represented mathematically as follows. To simplify the description, the equations below only demonstrate computation around the left current electrode 104.

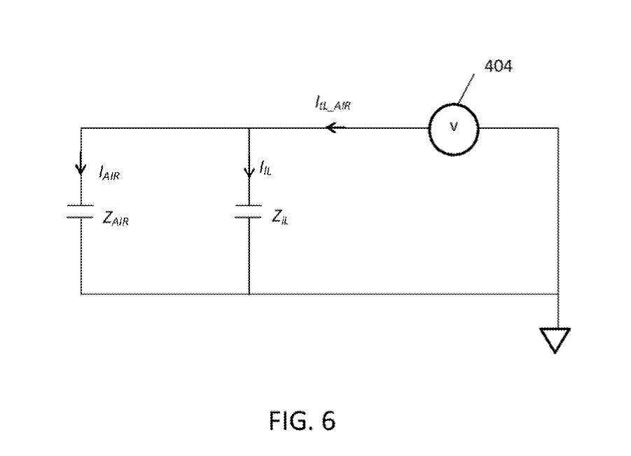

FIG. 6 shows a simplified circuit model for the left current electrode 104 of the sensor pad 100 suspended in the air. When the sensor pad 100 is suspended in the air (first medium), the total transmitting impedance with respect to the reference voltage of the sensor pad 100 can be approximated as a combination of two parallel capacitive impedances Z_{iL} and Z_{AIR}. Z_{iL} is the internal capacitive impedance between the current electrode 104 and the metal body 200 of the sensor pad 100 and Z_{AIR} is a capacitive impedance between the current electrode 104 and the air. The total currents at the current electrode 104 can be expressed as follows:

$$\frac{V}{{Z}_{iL}} + \frac{V}{{Z}_{AIR}} = {I}_{tL \_ AIR} \qquad ( 2 )$$

where V can represent the amplitude of the alternating source voltage provided by the voltage source 404 in the FIG. 5; and where I_{tL}_{_{—}}_{AIR} can represent the total current measured by the current sense amplifier 506 in the FIG. 5, which would be equal to the current at the current electrode 104.

When the sensor pad 100 is suspended in the oil (second medium), the total transmitting impedance with respect to the reference voltage of the sensor pad 100 can be approximated as a combination of two parallel capacitive impedances Z_{iL} and Z_{OIL}. Z_{iL} is the internal capacitive impedance between the current electrode 104 and the metal body 200 of the sensor pad 100 and Z_{OIL} is a capacitive impedance between the current electrode 104 and the oil. Z_{OIL} can be denoted as follows:

$${Z}_{OIL} = \frac{{Z}_{AIR}}{{ɛ}_{r}} \qquad ( 3 )$$

where ∈ᵣ is the ratio of the dielectric constants of the oil and air.

The total currents at the current electrode 104 then can be expressed as follows:

$$\frac{V}{{Z}_{iL}} + \frac{V}{{Z}_{AIR}} {ɛ}_{r} = {I}_{tL \_ OIL} \qquad ( 4 )$$

where V can represent the amplitude of the alternating source voltage provided by the voltage source 404 in the FIG. 5; and where I_{tL}_{_{—}}_{OIL} can represent the total current measured by the current sense amplifier 506 in the FIG. 5, which would be equal to the current at the current electrode 104.

Then, the internal capacitive impedance Z_{iL} can be solved from Equations (2)-(4) and expressed as follows:

$${Z}_{iL} = \frac{V ( {ɛ}_{r} - 1 )}{{I}_{tL \_ AIR} - {I}_{tL \_ OIL}} \qquad ( 5 )$$

Accordingly, the leakage current I_{lL} can be obtained and expressed as follow:

$${I}_{IL} = \frac{V}{{Z}_{iL}} \qquad ( 6 )$$

In some embodiments, the voltage source 404 can be a voltage source with constant amplitude, and therefore the leakage currents I_{lL} is independent from the environment where the sensor pad is located. As such, the leakage current I_{lL} can be used as a base current and subtracted from the measured total current I_{tL} in the borehole.

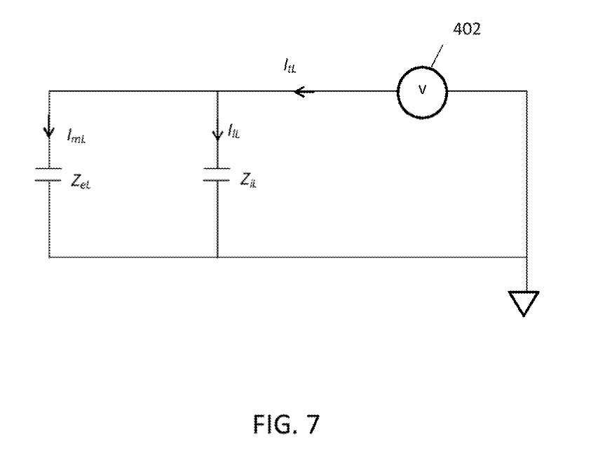

When the sensor pad 100 is suspended in the borehole, at a frequency of not less than 20 kHz, the external capacitive impedances Z_{eL} and Z_{eR} in FIG. 5 caused by the mud would be supposed to be much larger than the formation resistances R_{fL}, R_{f} and R_{fR}. Therefore, for the left constant voltage source 404, the transmitting impedance with respect to the reference voltage of the sensor pad 100 can be approximated as a combination of two parallel capacitive impedances Z_{iL} and Z_{eL} as shown in FIG. 7. Z_{iL} is the internal capacitive impedance between the current electrode 104 and the metal body 200 of the sensor pad 100 and Z_{eL} is the external capacitive impedance between the current electrode 104 and the formation 102. According to FIG. 7, the measuring current I_{mL} can be expressed as follows.

I_{mL}=I_{tL}−I_{lL} (7)

Accordingly, the external capacitive impedance Z_{eL} between the current electrode 104 and the formation can be obtained and expressed as follows.

$${Z}_{eL} = \frac{V}{{I}_{mL}} \qquad ( 8 )$$

Referring to the FIG. 5, the measuring current I_{mL} can be obtained by subtracting the leakage current I_{lL} from the measured total current I_{tL}. The leakage current I_{lL} can flow into the grounded body of sensor pad 100 with the current electrode 104 being isolated by oil mud or mud cake in the borehole. The measuring current I_{mL} can flow into the borehole 500, including the formation 102 and the mud layer 112 depicted in the FIG. 4. The portion of measuring current I_{mL} flowing into the formation 102 can generate voltage drop between the pair of voltage electrodes 108 and 110 accordingly, which can contain the information of formation resistivity. The other portion of measuring current I_{mL}, flowing into the mud layer 112 can also generate voltage drop between the pair of voltage electrodes 108 and 110 accordingly. However, this parasite potential drop caused by the mud layer 112 contains no information of formation resistivity and can be treated as noise during measurement of formation resistivity.

The external capacitive impedance Z_{eL} is directly related to the standoff effect between the current electrodes and the formation. The larger the capacitive impedance Z_{eL} is, the less the currents flow into formation. The larger standoff distance due to a thick mud layer between the current electrodes and the wall of formation, the larger the capacitive impedance Z_{eL}. In the Equation (1), the reduction of the potential drop dV due to the standoff effect can be compensated by correcting the geometric coefficient k.

A pre-built chart can be established to show corresponding geometric factors to the external capacitive impedances with different standoff distances, dielectric constants, and resistivities of oil mud. The chart can be built by either numerical modeling or calibration experiments. For example, to build the chart through numerical modeling, formation resistivity Rₜ and the constant voltage on current electrodes V can be pre-defined. The potential drop dv on the voltage button pairs and the current flowing into mud and formation I_{mL} can be calculated through modeling for different standoff distances and electrical properties of oil mud. The external capacitive impedance Z_{eL} and geometric factor k can then be calculated by using the Equation (8) and the Equation (1) respectively. A chart containing cross plots of 1/k versus Z_{eL} can then be established in this way for different standoff distances and electrical properties of oil mud.

Similar process can be done with the right voltage source 406 and the current electrode 106. The external capacitive impedance Z_{eR} which is associated with the right current electrode 106 can be obtained in the similar manner. Since the external capacitive impedances Z_{eL} and Z_{eR} reflect the capacitive coupling between the current electrodes 104 and 106 and the formation, the difference between Z_{eL} and Z_{eR} can be used as an indication of tilt level of the sensor pad 100.

In some embodiments, once the difference between Z_{eL} and Z_{eR} exceeds a certain criteria (e.g. 10%), the data associated with the mismatched impedances Z_{eL} and Z_{eR} can be marked as bad quality.

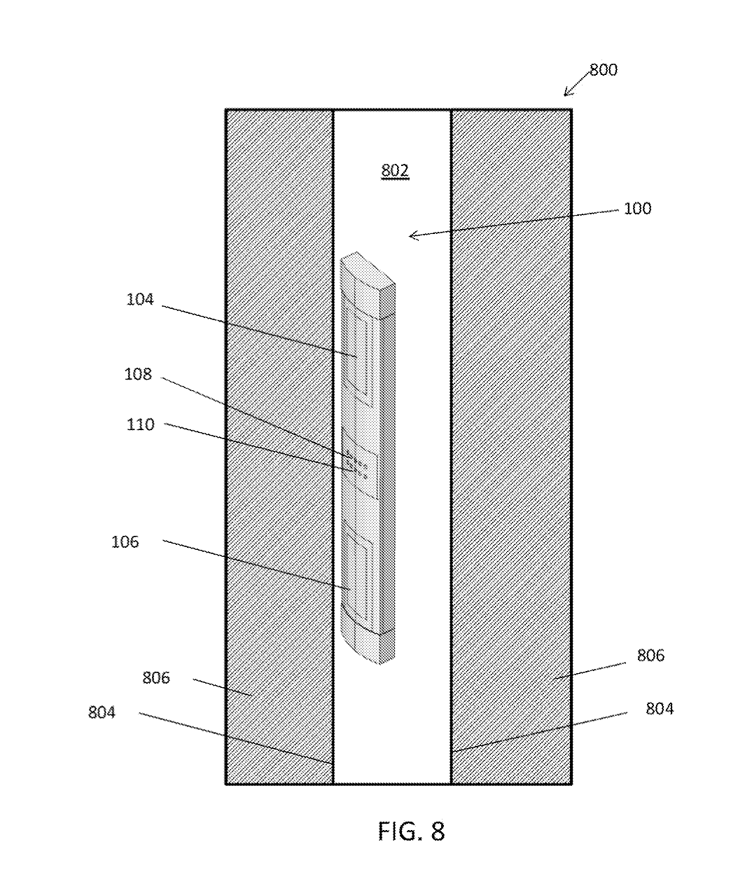

FIG. 8 illustrates an exemplary model 800 used for demonstrating the cross relationship between the geometric factor k and the external capacitive impedance Z_{eL}. In the FIG. 8, the sensor pad 100 as shown in FIG. 4 can be applied against a borehole wall 804. The borehole 802 where the sensor pad 100 is located can be filled with oil mud. The resistivity of the formation 806 can vary from 0.1 Ω*m to 2000 Ω*m. An alternating voltage sources with constant amplitude can be applied on the two current electrodes 104 and 106. The frequency of the voltage sources can be 20 kHz. Differential voltages on the pair of voltage electrodes 108 and 110 can be calculated for different combinations of oil mud electrical characteristics and different sensor standoff distances (2 mm, 4 mm, 6 mm and 8 mm respectively). The standoff distance is the distance between the sensor pad 100 and the borehole wall 804.

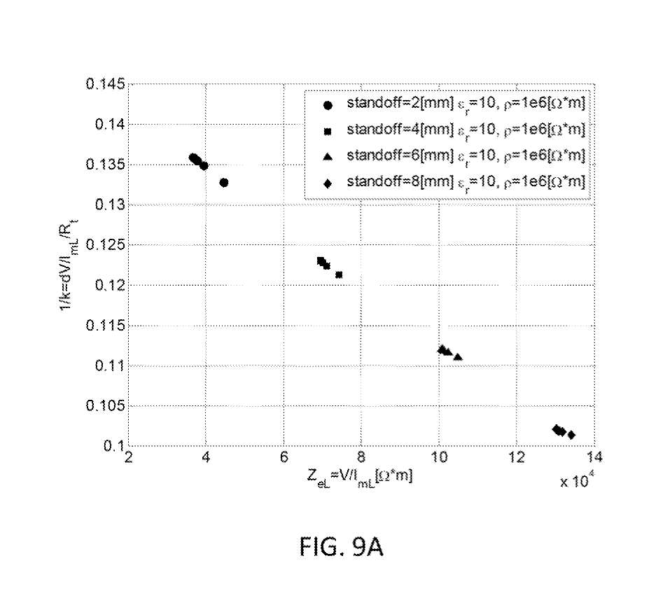

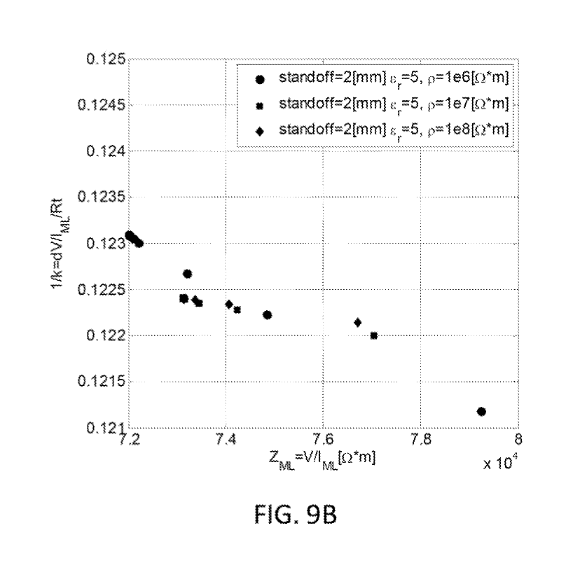

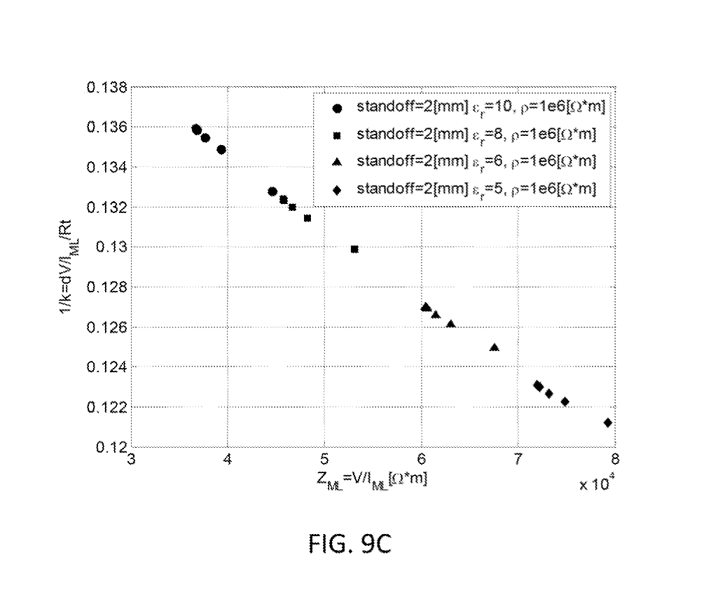

FIGS. 9A, 9B and 9C show the simulation results of the model 800 provided in FIG. 8. It shows the cross plot of the inverse of the geometric factor k versus the external capacitive impedance Z_{eL}. The legend of the plot can show the combination of formation resistivity ranging from 0.1 Ω*m to 2000 Ω*m., sensor pad's standoff distance from the borehole wall, the dielectric constant of the oil mud (denoted as ∈ᵣ) and the resistivity of the oil mud (denoted as p). For example, there are 10 solid circles on the plot of FIG. 9A corresponding a standoff distance of 2 mm, a dielectric constant of oil mud of 10, a resistivity of oil mud of 10⁶ Ω*m, and 10 formation resistivities of 0.1 Ω*m, 0.5 Ω*m, 1 Ω*m, 5 Ω*m, 10 Ω*m, 50 Ω*m, 100 Ω*m, 500 Ω*m, 1000 Ω*m and 2000 Ω*m respectively.

The ordinate of the plots shown in FIG. 9A, 9B and 9C, 1/k, can be obtained from the Equation (1). dV represents the differential voltage measured on the pair of voltage electrodes 108 and 110. I_{mL}, which represents measuring currents entering into the formation, can be obtained from the Equation (7). Rt represents the resistivity of the formation. The abscissa of the plot, Z_{eL}, can be obtained from the Equation (8) and represents the external capacitive impedance due to the oil mud.

From the plot in the FIGS. 9A, 9B and 9C, it can be seen that the formation resistivity (ranging from 0.1 to 2000 Ω*m) and the oil mud resistivity (ranging from 10⁶ to 10⁸ Ω*m) have little effect on the geometric factor k. The dielectric constant of the oil mud and the sensor pad's standoff distance have significant effect on the geometric factor k. Different dielectric constants of the oil mud and the standoff distances can be reflected by the capacitive impedance Z_{eL} due to the oil mud as shown in the plots. Therefore, the borehole environment (including the electrical properties of the oil mud and sensor pad's standoff) can be characterized by the capacitive impedance Z_{eL}.

In practice, the plots shown in FIGS. 9A, 9B and 9C can be established by either numerical modeling or calibration experiments once the configuration and the frequency of the sensor pad are determined. During the operation of the sensor pad in borehole environment, the external capacitive impedance Z_{eL} can be calculated based on the measurements of total currents and leakage currents. Based on the obtained Z_{eL}, the proper geometric factor k can be obtained by looking up the plot and the effect of the borehole environment can be corrected.

In some embodiments, the plots in FIGS. 9A, 9B and 9C can be fitted as a polynomial curves or other fitting curves so that the cross relationship between the geometric factor k and the external capacitive impedance Z_{eL} can be embodied as an expression which can be implemented in the firmware of the downhole circuitry.

In some embodiments, two geometric factors k_{L} and k_{R} can be obtained based on the two external capacitive impedances Z_{eL} and Z_{eR}. The final geometric factor k used for calculating formation resistivity can be the average of the k_{L} and k_{R} and can be expressed as follows.

$$k = \frac{{k}_{L} + {k}_{R}}{2} \qquad ( 8 )$$

In some embodiments, the sensor pad 100 can be coupled with a storage device to be stored with the pre-built chart.

In some embodiments, the sensor pad 100 can be coupled with a processor to calculate resistivity of the formation.

The storage device and the processor (not shown in Figures) can be physically connected to the sensor pad 100 or remotely coupled to the sensor pad 100.

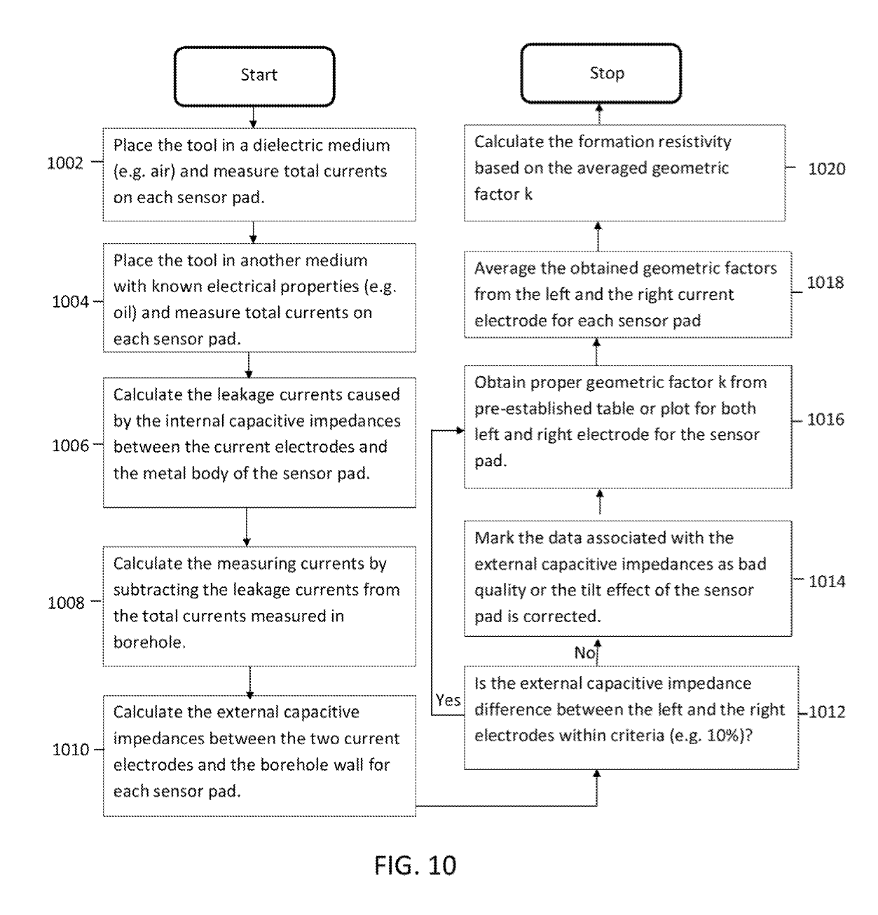

FIG. 10 shows a flow diagram of a correction method for an oil based mud imager with the sensor pad shown in FIG. 4. In block 1002, the tool is placed in a dielectric medium (e.g. air) and total currents from current electrodes are measured. In block 1004, the tool is placed in another dielectric medium (e.g. oil) and the total currents from current electrodes are measured. In block 1006, the leakage currents caused by internal capacitive impedances between the current electrodes and the metal body of the sensor pad is calculated based on the measurements from the blocks 1002 and 1004. The actual measuring currents injected into the formation are obtained in block 1008 by subtracting the calculated leakage currents from the total currents measured in the borehole. In block 1010, external capacitive impedances between the two current electrodes and the borehole wall are calculated. In block 1012, the two external capacitive impedances associated with the two current electrodes are compared. If the difference of the two external capacitive impedances is within a pre-determined criteria, the external capacitive impedances can be used to obtain proper geometric factors by looking up a pre-established table or plot in block 1016. If the difference of the two external capacitive impedances exceeds the pre-determined criteria, the data associated with the external capacitive impedances will be marked as bad quality or the tilt effect of the sensor pad is corrected in the block 1014. In block 1018, the obtained geometric factors associated with the two current electrodes can be averaged for each sensor pad. In block 1020, the formation resistivity is calculated based on the averaged geometric factor for each sensor pad.

The present invention is in no way limited to any number of sensor pad coupled to the OBMI or any imaging or logging tool.

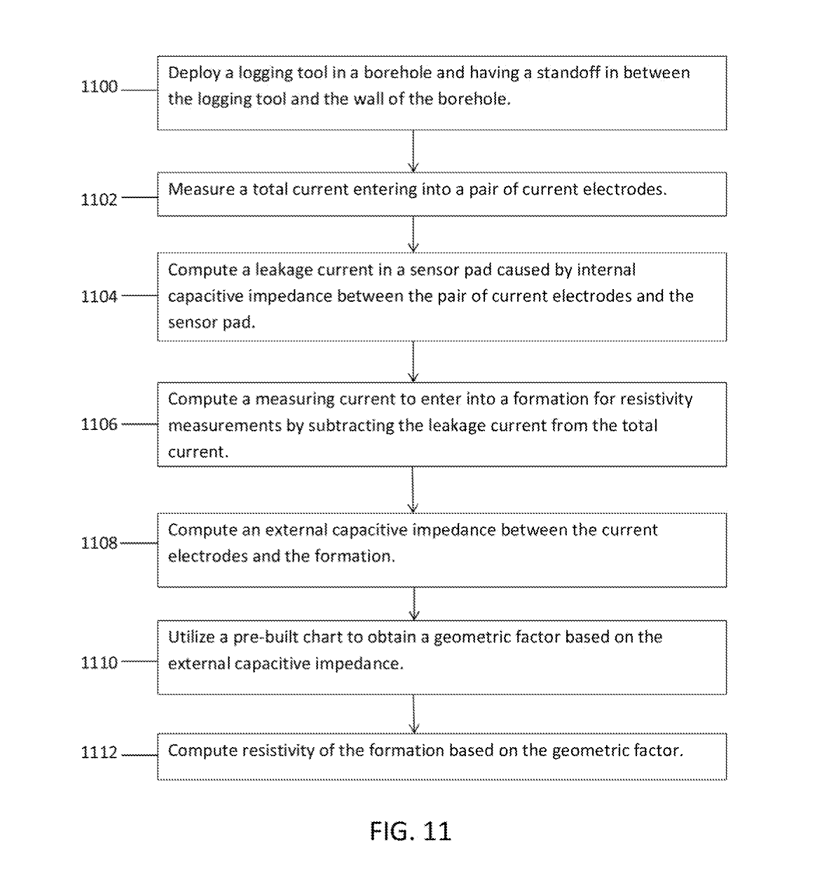

FIG. 11 shows a flow diagram of a logging method for correcting resistivity measurements of formation surrounding a borehole. The method can include deploying a logging tool in the borehole and having a standoff in between the logging tool and the wall of the borehole 1100, measuring total currents entering into the pair of current electrodes 1102, computing leakage currents in the sensor pad caused by internal capacitive impedances between the pair of current electrodes and the sensor pad 1104, computing measuring currents to enter into the formation for the resistivity measurements by subtracting the leakage currents from the total currents 1106, computing external capacitive impedances between the current electrodes and the formation 1108, utilizing a pre-built chart to obtain a geometric factor based on the external capacitive impedance 1110, and computing resistivity of the formation based on the geometric factor 1112.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A correction method for resistivity measurements of formation surrounding a borehole comprising:
deploying a logging tool in the borehole and having a standoff in between the logging tool and the wall of the borehole; wherein the logging tool including a sensor pad embedded with a pair of current electrodes and a pair of voltage electrodes and a measurement circuit; wherein the current electrodes and voltage electrodes being insulated from the main body of the sensor pad; and wherein the measurement circuit providing source voltages to the pair of current electrodes;
measuring a total current entering into the pair of current electrodes;
computing a leakage current in the sensor pad caused by an internal capacitive impedance between the pair of current electrodes and the main body of the sensor pad;
computing a measuring current to enter into the formation for the resistivity measurements by subtracting the leakage current from the total current;
computing an external capacitive impedance between the current electrodes and the formation;
utilizing a pre-built chart to obtain a geometric factor based on the external capacitive impedance; and
computing resistivity of the formation based on the geometric factor.

2. The method according to claim 1 wherein the internal capacitive impedance between the pair of current electrodes and the sensor pad is obtained by placing the sensor pad in two medium and measuring currents passing through them.

3. The method according to claim 2 wherein the currents passing through the two medium are expressed as follows:
$$\frac{V}{{Z}_{i}} + \frac{V}{{Z}_{1}} = {I}_{1} ;$$
$$\frac{V}{{Z}_{i}} + \frac{V}{{Z}_{1}} {ɛ}_{r} = {I}_{2}$$
wherein V is the amplitude of alternating source voltage; wherein ∈ᵣ is the ratio of the dielectric constants of the two medium; wherein I₁ is the measured current flow at the pair of current electrodes when the sensor pad is deployed in the first medium; and wherein I₂ is the measured current flow at the pair of current electrodes when the sensor pad is deployed in the second medium.

4. The method according to claim 3 wherein the internal capacitive impedance is computed as follows:
$${Z}_{i} = \frac{V ( {ɛ}_{r} - 1 )}{{I}_{1} {ɛ}_{r} - {I}_{2}}$$

5. The method according to claim 1 wherein the external capacitive impedance is computed as follows:
$${Z}_{e} = \frac{V}{{I}_{m}}$$
wherein V is the amplitude of alternating source voltage; and wherein Iₘ is the measuring currents to enter into the formation for resistivity measurements.

6. The method claim according to claim 1 further comprising checking the consistency of the external capacitive impedances when multiple external capacitive impedances are computed between each of the current electrodes and the formation.

7. The method claim according to claim 6 wherein the difference between multiple external capacitive impedances indicates a tilt level of the sensor pad.

8. The method claim according to 7 wherein the external capacitive impedances are corrected when the difference exceeds pre-defined criteria.

9. The method claim according to 6 wherein multiple geometric factors are obtained based on multiple external capacitive impedances.

10. The method according to claim 9 wherein a final geometric factor for computing formation resistivity is the average of multiple geometric factors.

11. The method according to claim 1 further comprises building the pre-built chart which includes the data of geometric factor versus the external capacitive impedance with different standoffs and electrical characteristics of medium.

12. The method according to claim 1 wherein the sensor pad is connected to the measurement circuit.

13. The method according to claim 1 wherein the measurement circuit comprises two voltage sources connected to the pair of current electrodes.

14. The method according to claim 13 wherein the phase difference between the pair of voltage sources is 180 degrees.

15. The method according to claim 1 wherein the measurement circuit comprises a transformer and a current sense amplifier to measure the total current entering into the current electrodes.

16. The method according to claim 1 wherein the measurement circuit comprises a processor to calculate resistivity.

17. The method according to claim 1 wherein the measurement circuit comprises a differential amplifier to measure the voltage potential between the pair of voltage electrodes.

18. The method according to claim 1 wherein the sensor pad includes a pair of standoff devices deployed at the two ends of the sensor pad to prevent direct contact between the sensor pad and the formation.

19. The method according to claim 1 wherein the results of multiple resistivity measurements generate an image of the borehole.

20. A correction method for resistivity measurements of formation surrounding a borehole comprising:
providing a sensor pad; wherein the sensor paid being embedded with at least a pair of current electrodes and at least a pair of voltage electrodes; wherein the current and voltage electrodes being covered with an insulator; and wherein the voltage electrodes being deployed between the current electrodes;
providing a pair of voltage sources connecting to the pair of current electrodes;
providing transformers and current sense amplifiers to measure currents out of the voltage sources;
providing a differential amplifier to measure and sample the voltage difference between the pair of voltage electrodes;
providing a storage device to be stored with a pre-built chart including data of geometric factors in consideration of an internal capacitive impedance in the sensor pad and an external capacitive impedance between the current electrodes and the formation; and
providing a processor to calculate resistivity of the formation based on the geometric factor.

21. A correction method for resistivity measurements of formation surrounding a borehole comprising:
obtaining an internal capacitive impedance and a leakage current in a sensor pad; wherein the sensor pad including at least a pair of current electrodes and at least a pair of voltage electrodes;
computing an external capacitive impedance between the current electrodes and the formation; and
calibrating a geometric factor in consideration of the internal and external capacitive impedances to calculate resistivity of the formation.

22. The method according to claim 21 wherein the calibration is performed by numerical modeling or calibration experiments.
